(19) United States
(12) Patent Application Publication
(10) Pub. No.: US 2019/0335739 A1
(43) Pub. Date: Nov. 7, 2019

(54) RACCOON TRAP

(71) Applicant: Robert E. Allen, Churdan, IA (US)

(72) Inventor: Robert E. Allen, Churdan, IA (US)

(21) Appl. No.: 15/969,933

(22) Filed: May 3, 2018

(51) Int. Cl. A01M 23/24

(52) U.S. Cl. CPC A01M 23/24

(57) ABSTRACT

A live trap for capturing an animal by its paw includes a hollow body with a ground stake. A lever assembly, jaw, latch, and trigger are pivotally mounted on the body for movement between a released position and a set position. A trapper can squeeze the lever to automatically set the trap without touching the latch or the trigger. A latch guide on the lever and a curved surface on the trigger direct the latch into retentive engagement with a notch in the trigger for setting the trap. The latch is released by an animal withdrawing its paw from a position behind the trigger, where bait resides.

### FIELD OF THE INVENTION

The invention is directed to live animal traps, and particularly to a paw trap for catching raccoons and similar animals.

### BACKGROUND OF THE INVENTION

Various types of traps have been used for many years for catching raccoons and similar animals. One popular trap is a paw trap which clamps the raccoon's paw when the raccoon reaches into the trap to get to the bait inside the trap. Some paw traps have a one-way trigger which is actuated by the raccoon's paw after reaching the bait behind the trigger and trying to withdraw their paw so as to pull the trigger and thereby disengage the latch. Other paw traps have two-way triggers, which can be actuated by either pushing or pulling by the animal's paw so as to trip the trigger and release the jaw into clamping action again the wrist or paw.

These paw traps are relatively simple in construction but can be difficult to set. The paw traps are spring biased and normally require the trapper to squeeze the trap jaw against the spring bias and then hold the trap with one hand while using the other hand to engage the latch into the trigger, so as to set the trap.

There is a need for an improved paw trap, which is easier to set, yet simple in construction and use.

Accordingly, a primary objective of the present invention is the provision of an improved live animal trap which overcomes the problems of the prior art.

Another objective of the present invention is the provision of a raccoon trap which prevents accidental tripping of the trigger.

A further objective of the present invention is the provision of a raccoon paw trap which can be quickly and easily set using only one hand.

Still another objective of the present invention is the provision of a dog proof raccoon trap which has a lever for setting the trap.

Another objective of the present invention is the provision of a dog proof animal paw trap having a guide to automatically align the latch with the trigger notch as the jaw is moved toward the set position.

Another objective of the present invention is the provision of an animal paw trap having a trigger with a curved surface to slidably receive the trap latch into the trigger notch.

Still another objective of the present invention is the provision of an animal paw trap having a tubular body with a stake attached in an angular orientation relative to the longitudinal axis of the body.

A further objective of the present invention is the provision of a raccoon paw trap which is economical to manufacture, safe to use, and effective in trapping an animal.

These and other objectives will become apparent from the following description of the invention.

### SUMMARY OF THE INVENTION

A trap for catching an animal's paw, such as a raccoon, includes a hollow tubular body with forward and rearward ends, and with a jaw at the forward end adapted to clamp against the animal's paw when the trap is released from a set position. A lever is pivotally mounted to the body, with forward and rearward ends residing on opposite sides of the body. A trigger is pivotally mounted on the body and extends through an opening so as to have interior and exterior ends. A latch is pivotally attached to a plate mounted on the front of the body, extends through a latch guide, and has a rear end adapted to releasably engage a notch on the trigger. The trap is set by squeezing the rear end of the lever, which automatically moves the latch into engagement with the trigger notch via the latch guide while the jaw into the set position within the hollow body.

The movement of the latch is guided by the U-shaped guide fixed on the front end of the lever. The lower or exterior end of the trigger has a curved surface which allows the latch to slide into engagement with the notch as the lever is depressed. A spring mounted on the body engages the rear end of the lever to bias the lever to release the jaw, which is connected to the forward end of the lever, from the set position. A stake is attached to the body and extends angularly relative to the longitudinal axis of the body, so that when the stake is inserted into the ground, the body preferably extends in a non-vertical orientation.

In use, after the trap is baited and set, the animal can reach into the front end of the body in an effort to reach bait located behind the trigger. When the animal begins to remove its paw, forward contact with the trigger disengages the latch so as to release the jaw due to the bias of the spring and catch the animal's paw.

### BRIEF DESCRIPTION OF THE DRAWINGS

FIG. 1 is an upper rear perspective view of the animal paw trap in an unset position, according to the present invention.

FIG. 2 is a lower front perspective view of the trap shown in FIG. 1.

FIG. 3 is a partially exploded view of the trap.

FIG. 4 is a perspective view showing the trap in a set position, with the body shown in broken lines to illustrate the internal components of the trap, and with the spring removed for clarity.

FIG. 5 is another perspective view similar to FIG. 4 showing the components of the trap in the unset position.

FIG. 6 is an enlarged elevation view showing the latch and the trigger in a set position.

FIG. 7 is a bottom plan view showing the latch and the trigger in a set position.

FIG. 8 is a sectional view of the body subassembly taken along a longitudinal vertical plane.

FIG. 9 is a perspective of the lever assembly.

FIG. 10 is a perspective view of the hoop jaw of the trap.

### DETAILED DESCRIPTION OF THE PREFERRED EMBODIMENTS

The live animal paw trap of the present invention is generally designated in the drawings by reference numeral 10. The trap 10 includes a hollow tubular body 12 having a forward or top end 14 and a rearward or bottom end 16. In the preferred embodiment, the body 12 is square in cross section, though the body may have other shapes, such as round. The square body 12 has a top wall 18, a bottom wall 20 and opposite sidewalls 22.

A base or bottom plate 24 is fixed inside the body 12 and functions as an internal rear wall of the body. The base plate 24 includes a hole 25 to allow drainage of precipitation from the body 12.

A latch mount plate 26 is fixed on the front end 14 of the body 12. As seen in the drawings, in the preferred embodiment, the back portion of the body 12 is sloped. A lever assembly 28 is pivotally mounted to the opposite sidewalls 22 of the body 12. The lever assembly 28 includes a U-shaped rod 30 with a web or pad 32 at the rearward end, forming a lever arm for the trap 10. Lever mounting plates 34 are fixed to the rod 30. An axle or pin 36 extends through the lever plates 34 and corresponding holes 38 on the sidewalls 22 of the body so as to define the pivot axis for the lever assembly 28. Nylon washers 35 are preferably provided between the lever plates 34 and the body 12 of the trap. The rod 30 is stiff or rigid, such that a force applied on the pad 32 will be transmitted along the length of the rod 30.

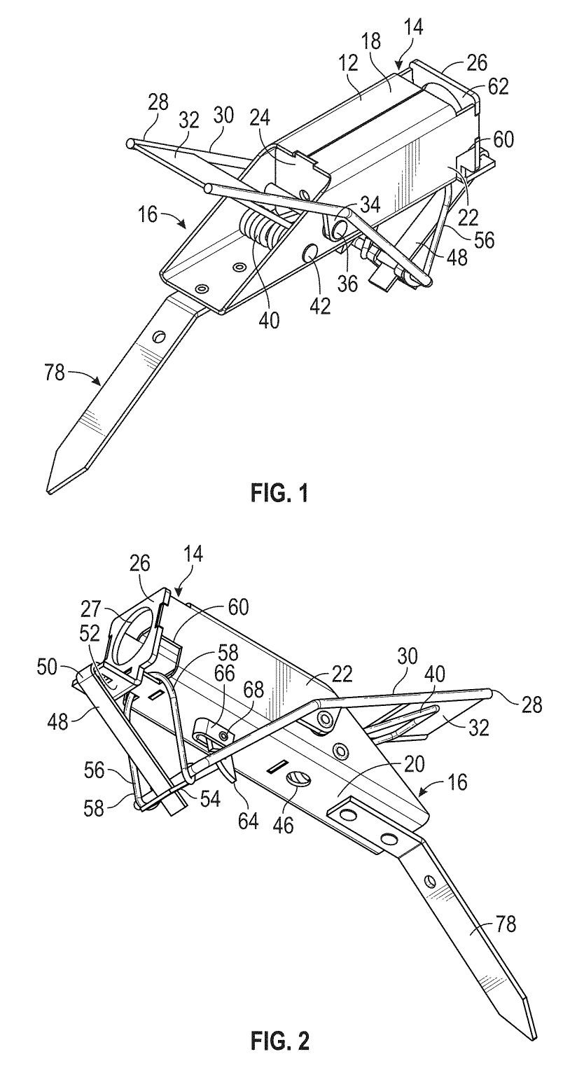

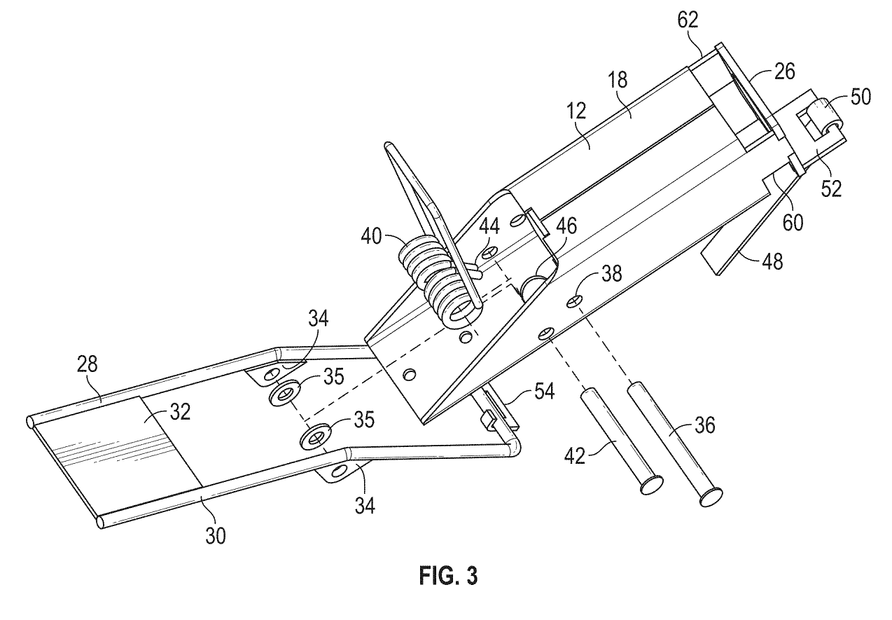

A double tortion spring 40 is mounted between the sidewalls 22 of the body 12 on a pin or axle 42. The ends 44 of the spring 40 extend into a hole 46 in the bottom wall 20 of the body 12. The spring engages the lever pad 32 so as to bias the lever assembly 28 against the set position of the trap 10, as shown in FIGS. 1 and 2.

An elongated latch 48 is mounted to the latch mount plate 26 on the front of the body 12. More particularly, the front end of the latch 48 has a hook 50 for pivotal receipt in a slot in a tab 52 extending forwardly from the mount plate 26. The rear end of the latch 48 slidably extends through a latch guide 54 welded or otherwise fixed to the forward end of the lever rod 30.

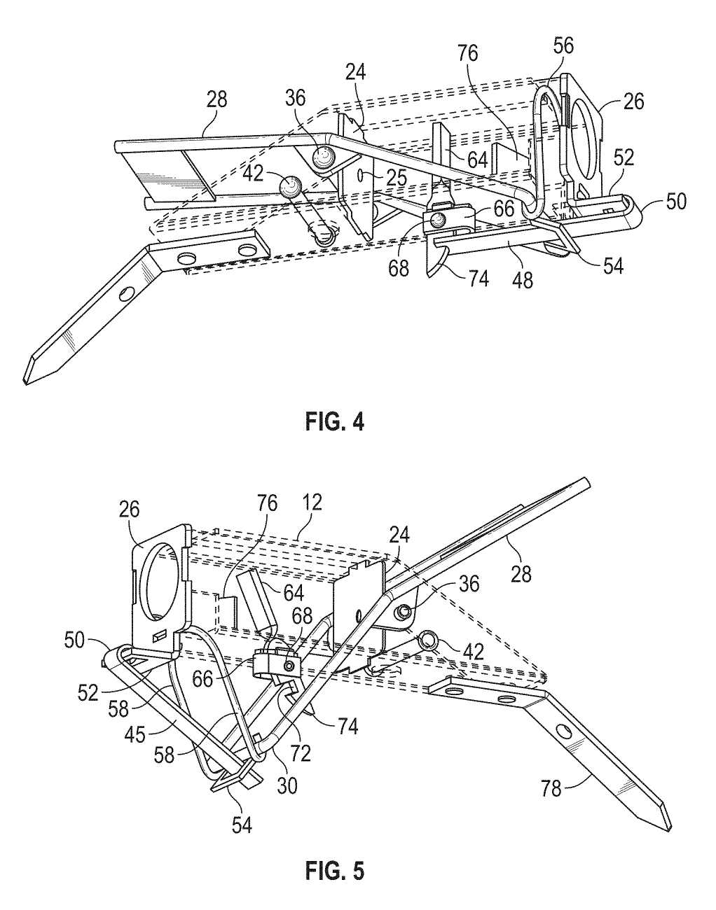

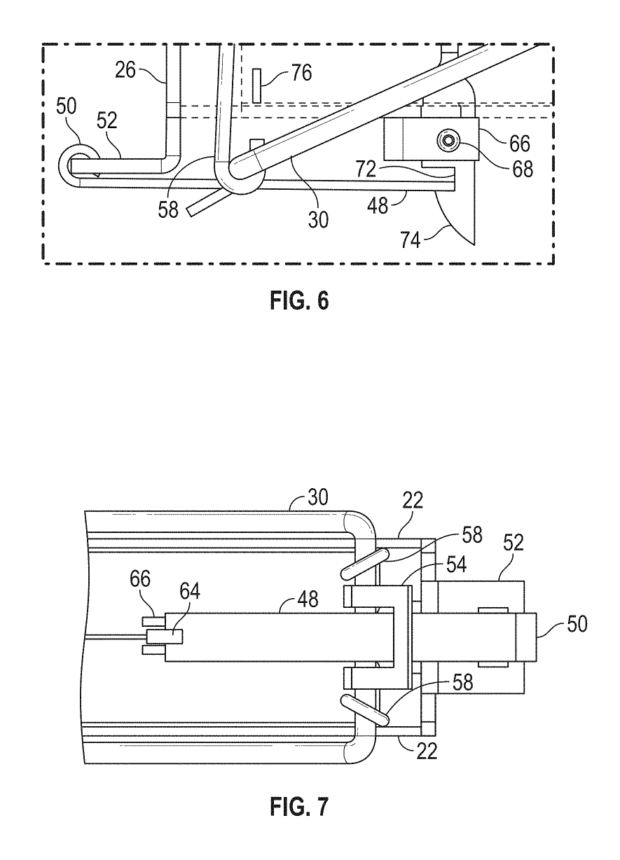

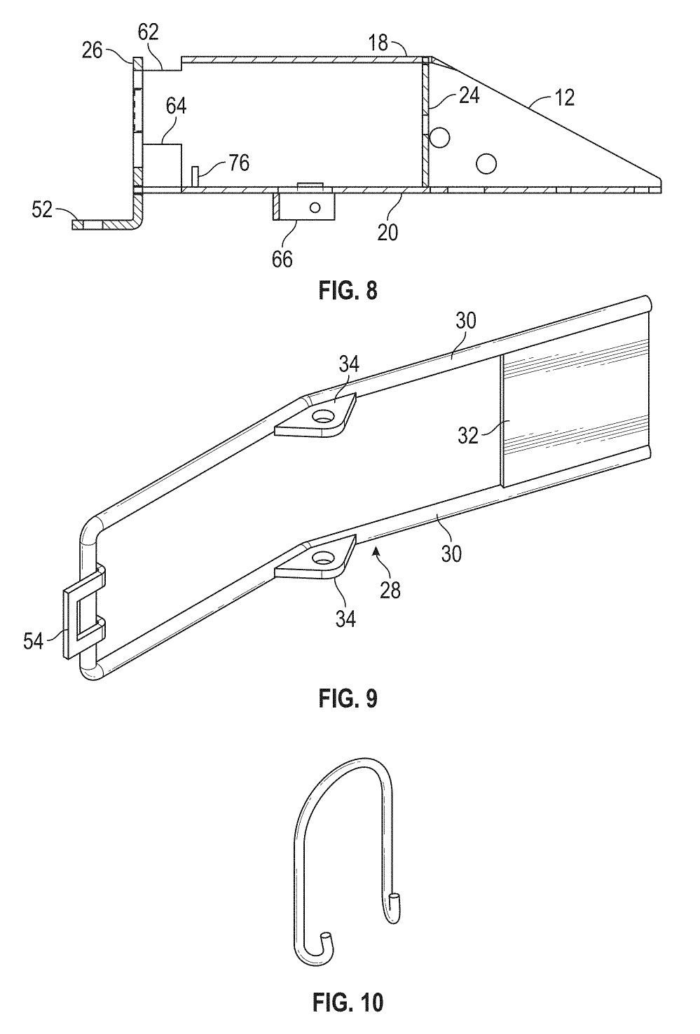

A trap jaw 56 in the form of a U-shaped rigid wire or rod has a pair of legs 58 which are hooked onto the forward end of the rod 30 of the lever assembly 28. The upper end of the hoop jaw 56 resides within the body 12, with the legs 58 being movable through notches 60 on the front bottom corners of the body 12. When the trap 10 is in a set position, the upper end of the jaw 56 may extend slightly through or beyond an upper notch 62 at the front end of the body, as shown in FIG. 4.

A trigger 64 is pivotally mounted on the body 12. As best seen in FIG. 4, a U-shaped trigger mount or bracket 66 is fixed on the bottom wall 20 of the body 12. The trigger 66 is pivotally mounted to the bracket 66 via a pin or rivet 68 and extends through a slot 70 in the bottom wall 20. The trigger rivet 68 is located below the midpoint of the trigger 64, as shown in FIGS. 4 and 5, such that the trigger is top heavy. Therefore, if the trap is held upwardly, the lower end of the trigger with the notch 72 will tend to pivot forwardly, and if the trap 10 is held downwardly, the lower end of the trigger 64 will pivot rearwardly.

The upper end of the trigger 66 resides within the body 12 and extends substantially the height of the body. The lower end of the trigger 64 extends downwardly beyond the mounting bracket 66 and includes a notch 72 for receipt of the rear end of the latch 48, so as to set the trap 10. The lower extremity of the trigger 64 has a curved surface along which the latch end slides as the trap is being set.

In a preferred embodiment a secondary jaw 76 may be mounted to the bottom wall 20 of the body 12. The dual jaws 56, 76 securely hold the animal's paw when the primary jaw 56 is released from the set position. It is understood that the secondary jaw 76 is not required, but virtually eliminates the chance that the animal can free itself once caught by the trap 10.

A stake 78 is fixed to the lower end of the body 12 by rivets or welding, and is preferably attached to a chain or cable (not shown) via a hole 80 in the stake, such that the chain or cable can be secured around a tree or other immovable object when a trap is being used. The stake 78 can be angularly disposed relative to the axis of the body 12.

In use, before the trap 10 is set, the trapper places the bait into the body between the base plate 24 and the trigger 64. Then the trap 10 can be moved from the neutral or released position shown in FIGS. 1 and 2 to the set position shown in FIG. 4 by squeezing the rear end of the lever assembly 28. A trapper can use one or both hands to squeeze the lever assembly 28 at the rear end so as to pivot the lever assembly about the axle 36. This pivoting action of the lever assembly moves the jaw 56 upwardly through the notches 60 while simultaneously pivoting the latch 48 and sliding the rear end of the latch through the latch guide 54 toward the trigger 64. As the rear end of the latch 48 engages the curved surface 74 of the trigger 64, the lower end of the trigger pivots rearwardly on the rivet 68 until the latch aligns with the trigger notch 72. Then, holding the front of the trap slightly inclined, the lower end of the trigger 64 pivots forwardly by gravity on the rivet 68 to engage the latch in the notch 72, and thereby set the trap 10.

The lever assembly 28 allows the trapper to set the trap without touching the latch 48 or the trigger 64. The latch guide 54 and the curved end 74 of the trigger 64 automatically guide the latch 48 into retentive engagement with the latch notch 72 as the lever assembly 28 is squeezed by the trapper, thereby safely setting the trap. The trapper can also safely release the trap from the set position by squeezing the rear end of the lever assembly 28 and tipping the trap 10 downwardly, such that the weight of the trigger 64 pivots the trigger about the rivet axle 68 so as to disengage the latch 48 from the trigger notch 72.

Once the trap 10 is set, it can be moved to a desired location by the trapper. For example, the stake 78 can be pushed into the ground. Due to the offset angular relationship between the stake 78 and the longitudinal axis of the body 12, if the stake is substantially vertical, the trap body will be slanted relative to the ground surface, which minimizes the risk that the raccoon or animal will accidentally bump the lower or exterior end of the trigger 64 and fire the trap. When the raccoon reaches its paw through the hole 27 in the latch mount plate 26 to get the bait behind the trigger 64, and then begins to withdraw its paw, the trigger will be pulled forwardly, thereby releasing the latch 48 from the trigger notch 72, which then releases the jaw 56 via the force of the tortion spring 40 on the lever assembly 28. The raccoon's paw will be caught and held by the jaw 56, such that the raccoon cannot escape. The paw or wrist of the raccoon will be secured between the primary jaw 56 and the secondary jaw 76. The trigger 64 is a one-way trigger, acting only when the animal begins to withdraw its paw from the trap, to disengage the latch 48. The trigger 64 will not disengage the latch 48 when the animal reaches its paw rearwardly towards the bait behind the trigger.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A trap for catching an animal's paw, comprising:
a tubular body with forward and rearward ends;
a jaw at the forward end of the trap;
a lever having a forward end attached to the jaw and a rearward end, and being pivotally mounted to the body between the forward and rearward ends;
a trigger pivotally mounted on the body; and
a latch pivotally mounted on the body and having a rear end adapted to releasably engage the trigger;
whereby squeezing the rear end of the lever automatically moves the latch into engagement with the trigger and moves the jaw into the body so as to set the trap.

2. The trap of claim 1 further comprising a guide on the forward end of the lever through which the latch slideably extends.

3. The trap of claim 1 wherein the trigger has a notch for receipt of the latch and a curved surface for engagement by the latch prior to receipt in the notch.

4. The trap of claim 1 further comprising a stake attached to the body and extending angularly relative to a longitudinal axis of the body.

5. The trap of claim 1 further comprising a double torsion spring mounted in the interior of the body and engaging rearward end of the lever to bias the lever to release the trap from the set position.

6. A paw trap for catching an animal, comprising:
a hollow body;
a jaw extendable into the body;
a trigger pivotally mounted to the body;
a latch pivotally mounted to the body;
a lever pivotally mounted to the body and connected to the jaw;
a torsion spring in the interior of the body to bias the arm to a release position;
a guide on the lever and through which the latch extends; and
whereby pivoting the lever away from the release position simultaneously moves the jaw into the body and positions the latch to lock the trigger in a set position.

7. The paw trap of claim 6 wherein the trigger has a notch for receipt of the latch and a curved surface for engagement by the latch prior to receipt in the notch.

8. The paw trap of claim 6 further comprising a stake attached to the body and extending angularly relative to a longitudinal axis of the body.

9. The paw trap of claim 6 wherein the lever has opposite ends residing on opposite sides of the body, with a pivot axle extending through the body.

10. An animal trap, comprising:
a hollow body;
a jaw extending into the body;
a trigger pivotally mounted to the body;
a latch pivotally mounted to the body;
the trigger having a curved end for sliding engagement by the latch and a notch above the curved end for receipt of the latch so as to set the trap.

11. The animal trap of claim 10 further comprising a lever arm pivotally mounted between opposite front and rear ends of the body, and the jaw being connected to the front end of the lever arm.

12. The animal trap of claim 11 further comprising a spring on the body to urge the lever arm and jaw to a position to catch an animal's paw when the trigger is disengaged from the latch.

13. The animal trap of claim 11 wherein the ends of the lever arm reside on opposite sides of the body.

14. The animal trap of claim 11 further comprising a stake attached to the body and extending angularly relative to a longitudinal axis of the body.

15. A paw trap for catching an animal by its paw, comprising:
a tubular body with forward and rearward ends;
a jaw at the forward end of the trap;
a trigger pivotally mounted on the body;
a latch pivotally mounted on the body and having a rear end adapted to releasably engage the trigger; and
a stake attached to the body and extending angularly relative to a longitudinal axis of the body.

16. The paw trap of claim 15 further comprising a lever pivotally mounted on the body and connected to the jaw and movable between set and release positions.

17. The paw trap of claim 16 further comprising a spring in the interior of the body to bias the lever toward the release position.

18. The paw trap of claim 17 wherein the spring is housed within the body.

19. The paw trap of claim 15 wherein the trigger has a notch for receipt of the latch and a curved surface for engagement by the latch prior to receipt in the notch.

20. The paw trap of claim 15 wherein the trigger is a one way trigger which moves from a set position engaging the latch to a release position disengaging the latch when pulled by an animal's paw, but not when pushed by the animal's paw.
